(19) United States
(12) Patent Application Publication
(10) Pub. No.: US 2013/0339864 A1
(43) Pub. Date: Dec. 19, 2013

(54) METHOD AND APPARATUS FOR PROVIDING MIXED-REALITY CONNECTIVITY ASSISTANCE

(71) Applicants: Mikko Aleksi Uusitalo, Helsinki (FI); Sergey Boldyrev, Soderkulla (FI); Jari-Jukka Harald Kaaja, Jarvenpaa (FI); Ian Justin Oliver, Soderkulla (FI); David Joseph Murphy, Helsinki (FI)

(72) Inventors: Mikko Aleksi Uusitalo, Helsinki (FI); Sergey Boldyrev, Soderkulla (FI); Jari-Jukka Harald Kaaja, Jarvenpaa (FI); Ian Justin Oliver, Soderkulla (FI); David Joseph Murphy, Helsinki (FI)

(73) Assignee: Nokia Corporation, Espoo (FI)

(21) Appl. No.: 13/524,431

(22) Filed: Jun. 15, 2012

(51) Int. Cl. G06F 15/177

(52) U.S. Cl. 715/736

(57) ABSTRACT

An approach is provided for providing connectivity assistance and the seamless interaction with information sources through a mixed-reality environment. A connectivity platform determines one or more connectivity options within an environment of at least one device. The connectivity platform further causes, at least in part, a presentation, within a user interface of the at least one device, of a mixed-reality representation of the environment including one or more symbols representing the one or more connectivity options.

### BACKGROUND

Service providers and device manufacturers (e.g., wireless, cellular, etc.) are continually challenged to deliver value and convenience to consumers by, for example, providing compelling network services. With the popularity of powerful mobile devices and computing devices in general, mixed-reality services provide new avenues for the provisioning of information. Further, new wired and wireless connection points are created offering users and their devices more ways of connecting to information sources and other devices. However, such mixed-reality services are often unidirectional by only providing information to a mobile device that is presented within a user interface. Further, many users are unaware of the presence of the multitude of connectivity options. Accordingly, service providers and device manufacturers face significant technical challenges in providing seamless interactions between the users of devices and the rich media content associated with the local environments of the users that allow that users to take advantage of the connectivity options.

### Some Example Embodiments

Therefore, there is a need for an approach for providing connectivity assistance and the seamless interaction of information sources through a mixed-reality environment.

According to one embodiment, a method comprises determining one or more connectivity options within an environment of at least one device. The method also comprises causing, at least in part, a presentation, within a user interface of the at least one device, of a mixed-reality representation of the environment including one or more symbols representing the one or more connectivity options.

According to another embodiment, an apparatus comprises at least one processor, and at least one memory including computer program code for one or more computer programs, the at least one memory and the computer program code configured to, with the at least one processor, cause, at least in part, the apparatus to determining one or more connectivity options within an environment of at least one device. The apparatus is also caused to present, within a user interface of the at least one device, of a mixed-reality representation of the environment including one or more symbols representing the one or more connectivity options.

According to another embodiment, a computer-readable storage medium carries one or more sequences of one or more instructions which, when executed by one or more processors, cause, at least in part, an apparatus to determining one or more connectivity options within an environment of at least one device. The apparatus is also caused to present, within a user interface of the at least one device, of a mixed-reality representation of the environment including one or more symbols representing the one or more connectivity options.

According to another embodiment, an apparatus comprises means for determining one or more connectivity options within an environment of at least one device. The apparatus also comprises means for causing, at least in part, a presentation, within a user interface of the at least one device, of a mixed-reality representation of the environment including one or more symbols representing the one or more connectivity options.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing mixed-reality representations of connectivity options and corresponding assistance in establishing connections, according to one embodiment;

FIG. 2 is a diagram of the components of a connectivity platform, according to one embodiment;

FIG. 3 is a flowchart of a process for presenting one or more connectivity options within a mixed-reality representation, according to one embodiment;

FIG. 4 is a flowchart of a process for establishing a connection between devices based on a mixed-reality representation, according to one embodiment;

FIG. 5 is a flowchart of a process for associating an application at a mobile device with a connectivity option, according to one embodiment;

FIG. 6 is a flowchart of a process for transferring information between sources through a mixed-reality representation, according to one embodiment;

FIG. 7 is a flowchart of a process for providing direction assistance associated with connectivity options through a mixed-reality representation, according to one embodiment;

FIGS. 8A and 8B are diagrams of user interfaces utilized in the processes of FIG. 3-7, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing connectivity assistance and the seamless interaction with information sources through a mixed-reality environment are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

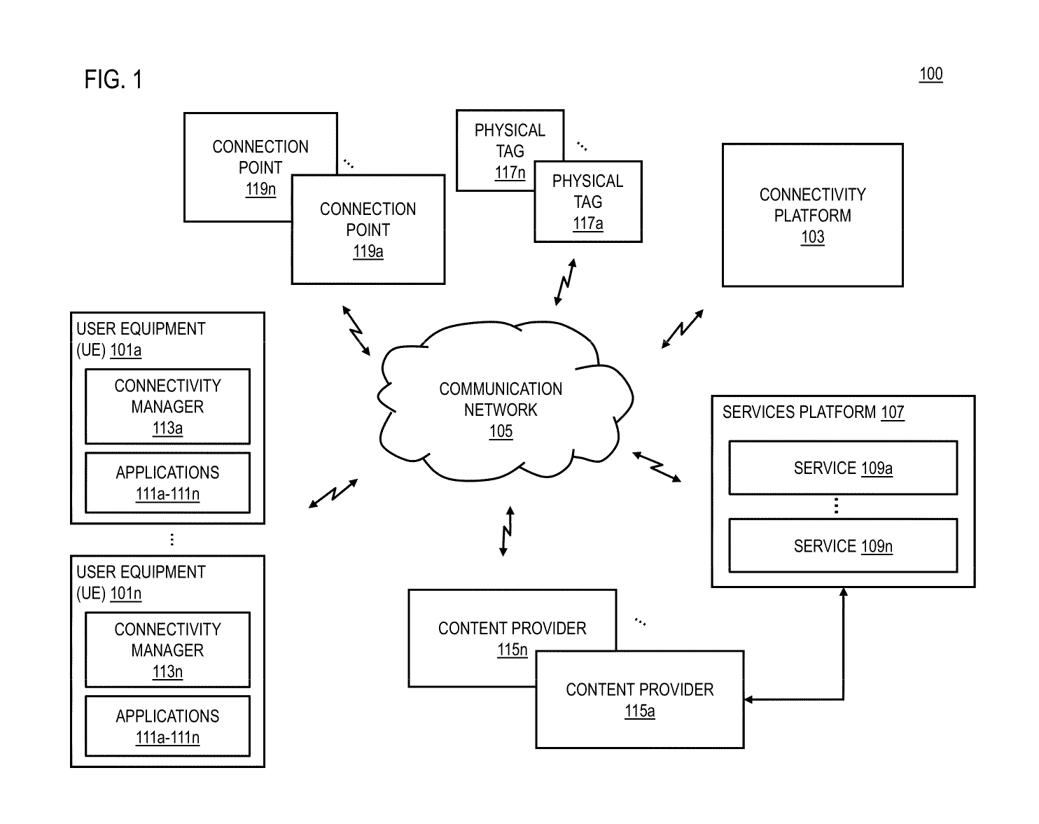

FIG. 1 is a diagram of a system capable of providing connectivity assistance and the seamless interaction with information sources through a mixed-reality environment, according to one embodiment. As the popularity of mobile devices grows, the number of possible connectivity options also grows. Connectivity options, including short-range, medium-range, and long-range connectivity options, are more common in various environments. However, users are often unaware of the existence of the connectivity options. Further, the users are often unaware of the data and computational structures that are associated with connecting to the connectivity options. This leaves the users unable to connect to the various connectivity options. Further, this leaves the users unable to exchange information with other devices associated with the connectivity options. In some situations, even with the knowledge of the connectivity options, users are unable to transfer information digital objects, such as one or more files, between devices through the connectivity options.

To address these problems, a system 100 of FIG. 1 introduces the capability to provide connectivity assistance and the seamless interaction with information sources through a mixed-reality environment. A mixed-reality environment allows for the merging of real and virtual worlds to produce visualizations and new environments. In a mixed-reality representation, physical and digital objects can co-exist and interact in real time. Thus, mixed-reality and the corresponding mixed-reality representation can be a mix of reality, augmented reality, virtual reality, or a combination thereof. The system 100 further provides the ability to present one or more symbols within a mixed-reality presentation of an environment at a user interface of a device. The one or more symbols represent one or more connectivity options that are present within the environment. A connection may be established between the connectivity options and the device based on, for example, one or more interactions between the user and the one or more symbols, such as dragging one of the symbols to an activation area of the user interface (e.g., a launch pad). Upon bringing a symbol representing a connectivity option to the activation area (e.g., launch pad), the system 100 provides the ability to establish a connection between the device and the connectivity option. The connection may be established based on data and/or one or more computational data structures associated with the connectivity option represented by the symbol. The system 100 also provides for a transfer of information between the device and the connectivity option and/or one or more other devices associated with the connectivity option. In one embodiment, the system 100 further provides one or more a visual indications of assisted connectivity routing guidance. Such guidance may indicate directions and/or movements associated with the device and/or the user of the device to establish a connection with a connectivity option that has less complex connectivity than other connectivity options.

As shown in FIG. 1, the system 100 comprises user equipment (UE) 101a-101n (collectively referred to as UE 101) having connectivity to a connectivity platform 103 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, near field communication (NFC), Internet Protocol (IP) data casting, digital radio/television broadcasting, satellite, mobile ad-hoc network (MANET), and the like, or any combination thereof.

The UE 101 may be any type of mobile terminal, fixed terminal, or portable terminal including a mobile handset, station, unit, device, mobile communication device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

The UE 101 may include one or more applications 111a-111n (collectively referred to as applications 111) that may perform various functions or processes at the UE 101. By way of example, the applications 111 may include social network applications, Internet browsing applications, navigational applications, calendar application, organizational application, media applications, configuration applications, and the like. For example, one application may determine the location of a UE 101a within an environment and interface with one or more sensors associated with the UE 101a for determining a direction that a camera on the UE 101a may be facing. Based on the location and the direction of the UE 101a, the application (or one or more other applications) may present a mixed-reality representation of the environment surrounding the UE 101a through a user interface of the UE 101a as one or more images or videos of the environment are displayed at the user interface. The mixed-reality representation may include, for example, the direction the camera is facing overlaid on a live video of the environment. Further, other information may be overlaid on the images displayed at the user interface of the environment, such as information regarding restaurants, public transportation, weather, reviews of stores, etc. As discussed in detail below, the current system allows for the overlay of one or more symbols representing connectivity options within the surrounding environment to aid the user's connection to the connectivity options.

In one embodiment, a specific application at the UE 101 may be a connectivity manager 113a-113n (collectively referred to as connectivity manager 113). The connectivity manager 113 may interface with the connectivity platform 103 to provide one or more services, one or more functions and/or one or more processes provided by the connectivity platform 103 at the UE 101. Thus, where the connectivity platform 103 is independent from the UE 101 within the system 100, the connectivity platform 103 may interface and/or interact with the UE 101 through the connectivity manager 113. In one embodiment, all of the functions, services, and processes provided by the connectivity platform 103 may be embodied within the connectivity manager 113 such that the connectivity platform 103 is within the UE 101 rather than being a separate element within the system 100.

The system 100 further includes a services platform 107 that includes one or more services 109a-109n (collectively referred to as services 109). The services 109 may provide information, functions, and/or services to any of the elements of the system 100, such as to the UE 101 and/or to the connectivity platform 103. The services 109 may include any type of service, such as social networking services, information provisioning services (e.g., context information regarding the UE 101, news information, weather information, etc.), advertisement services, connectivity services, location-based services, etc. By way of example, one or more of the services 109 may provide information to the connectivity platform 103 regarding connectivity options that are present within a specified environment, such as within an environment surrounding a UE 101a. In addition to the general information of the connectivity options, the services 109 may provide the data and/or computational structures associated with the connectivity options for providing assistance to devices connecting to the connectivity options and location information regarding the origin locations associated with the connectivity options.

The system 100 also includes one or more content providers 115a-115n (collectively referred to as content providers 115). The content providers 115 may provide any type of content to the elements within the system 100. For example, the content may be media content (e.g., media in the form of audio, video, etc.), information content (e.g., news, weather, geography, etc.), document content, etc.

The system 100 further includes physical tags 117a-117n (collectively referred to as physical tags 117). The physical tags 117 may represent any type wireless non-contact system that is able to transmit data from the tag to a reader device. By way of example, the physical tags 117 may include RF memory tags, MMID tags, and the like. As discussed below, the physical tags 117 may be illustrated within the mixed-reality representations based on the position of the physical tags 117 relative to devices presenting the mixed-reality representations. The physical tags 117 may store information that may be accessed by devices connecting to the physical tags 117 either physically by manually interfacing with the physical tags and/or by virtually interfacing with the virtual tags by interfacing with connectivity options presented within a mixed-reality representation.

The system 100 further includes one or more connection points 119a-119n (collectively referred to as connection points 119). The connection points 119 may represent any device that provides connectivity for other devices. The connectivity may be wired or wireless. One or more services 109 and/or content providers 115 may have information regarding, for example, the location of the connection points, the type of connection points, pricing associated with the connection points, capacity associated with the connection points, etc. This information may be presented based on the symbols within the mixed-reality presentation within the user interface. The connection points 119 may provide the connectivity options that are provided within the mixed-reality representation at the devices.

The system 100 by way of the connectivity platform 103 allows for connectivity between devices, connection points, or a combination thereof by showing symbols representing the connectivity options in one or more mixed-reality representations. The mixed-reality representations present the environment surrounding a device at a user interface of the device including the symbols that represent the connectivity options. A user of the device may then connect to the connection points by dragging one or more of the symbols on the user interface to an activation area of the user interface representing, for example, a launch pad. Upon dragging a symbol to the launch pad, the connectivity platform 103 parses data and/or computational structures associated with the symbols and/or the connectivity options represented by the symbols. The connectivity platform 103 decomposes the data and/or computational structures into software elements that then instruct hardware elements at the device the parameters associated with connection to the connectivity options.

In one embodiment, the symbols representing the connectivity options can have various sizes, shapes, colors, etc. The various sizes, shapes, colors, etc. can visually indicate within the mixed-reality representation a type, a capacity (e.g., bandwidth, number of clients, etc.), a quality, a price, etc. associated with the corresponding connectivity options represented by the symbols. Thus, by way of example, the shape of the symbol may represent the type of the corresponding connectivity option, such as cellular, WLAN, cognitive radio, Bluetooth®, WiFi, WiMAX, DSL, modem, T1, close proximity connections, device-to-device direct memory access connections, etc. The size color or the size may represent any one of the other characteristics of the connectivity options.

Upon initiation a connection between a mobile device and a connection point by, for example, dragging a symbol representing a connectivity option to an activation area (e.g., a launch pad) on the user interface, the connectivity platform 103 can determine the credentials associated with the device and/or the user of the device that is requesting access and/or a connection to the connection point. Determining whether the device and/or the user of the device are associated with credentials allows for a validation of the device and/or the user for added levels of security associated with both the connectivity option and the devices. Depending on whether the device and/or the user are valid, the connectivity platform 103 will allow or disallow the parsing of the data and/or the computational structures associated with the symbol representing the connectivity option.

To initiate a connection to a connectivity option, the connectivity platform 103 allows users to drag the symbols representing the connectivity options to the launch pad associated with a user interface. However, in one embodiment, initiation of a connection may occur without requiring an active step by the user prior to the initiation. Instead, the connection may be initiated based on one or more preferences and/or restrictions. The user of the device, or another entity (such as a operator acting on behalf of the user, or an operator providing the connectivity option) can set preferences and/or restrictions regarding one or more symbols, one or more connectivity options, and/or one or more connection points 119 so that a connection is automatically established based on the preferences. Further, such preferences may be set associated with other stages of the connectivity, such as termination, transition and/or update. By way of example, a user may create a list of connectivity options to automatically connect to upon the symbols associated with the connectivity options appearing on the user interface of the user's device. Further, upon the symbols disappearing from the user interface of the device, one or more preferences created by the user may initiate a disconnection of the device from connectivity option.

In one embodiment, the activation area (e.g., a launch pad) enables dragging of a digital object (e.g., a symbol) from the mixed-reality representation and/or other screens within a user interface to activate the digital object. Once a digital object is activated within the activation area, the digital object may be composed, decomposed, parsed, or otherwise analyzed such that the digital object may be acted upon. In one embodiment, the digital object (e.g., a symbol) may represent a connectivity option. Upon dragging the digital object to the activation area, the digital object may be decomposed to determine the data, one or more computational structures, or a combination thereof associated with the connectivity option that define one or more software components associated with the connectivity option. Further, in one embodiment, the activation area may have the capability of creating and updating digital objects between a device and a mixed-reality representation presented at a user interface of the device. Furthermore, the activation area may provide backend support and expose processes associated with the applications 111, the services 109 and/or the content providers 115.

In one embodiment, by dragging the symbols representing the connectivity options to an activation area of the user interface, such as a launch pad, rather than initiating a connection with the connectivity option, instead parameters associated with the connectivity option may be selected. Such parameters may define the preferences and/or restrictions associated with the connectivity option. In one embodiment, there may be several activation areas associated with the user interface for dragging symbols over, such as one area for initiating a connection and one area for configuring parameters associated with the connectivity option.

The connectivity platform 103 further provides the ability to associate one or more applications and/or services at a device with a connectivity option. The user interface may include one or more icons overlaid on the mixed-reality representation of the environment within the user interface, or at the edges of the mixed-reality representation. The icons may be associated with one or more applications and/or one or more services at the device. The user may drag the symbols over the icons representing the applications and/or services, or may drag the icons over the symbols. Under either approach, the connectivity platform 103 may associate the applications and/or services with the particular connectivity option associated with the selected symbols. By way of example, a user may drag a first icon associated with a first application over a first symbol corresponding to a first connectivity option. Accordingly, communications associated with the first application may use the first connectivity option. A user may drag a second icon associated with a second application over a second symbol corresponding to a second, different application than the first application. Accordingly, communications associated with the second application may use the second connectivity options. Further, associating the symbols of connectivity options with the icons of applications and/or services by dragging the symbols and/or icons over each other may also allow the users to configure the connectivity between the applications, services, and connectivity options.

The connectivity platform 103 also provides a way to transfer files between devices that may be represented as connectivity options within the mixed-reality representations. A connection point may include another device, such as a mobile device. By dragging a symbol representing the mobile device over an activation area within the user interface, a connection between the device associated with the user interface and the mobile device may be established that allows for the transfer of information between the two devices. In one embodiment, one or more icons representing digital objects (e.g., files) or other types of information at a device may be presented within the user interface and the mixed-reality representation. A user may then drag the one or more icons over a symbol of a connectivity point to establish a transfer of the file to the connection point represented by the symbol.

The connectivity platform 103 may obtain information regarding the connectivity options from various information sources, such as one or more services 109, one or more content providers 115 and one or more of the UE 101. One or more services 109 and/or content providers 115 may act as databases regarding the locations and parameters of the connectivity options that the connectivity platform 103 interfaces with to provide to the user interfaces of the UE 101. Thus, the one or more symbols presented in the user interface may represent one or more virtual tags corresponding to the connectivity options.

In one embodiment, the UE 101 may detect connectivity options within the surrounding environment. The UE 101 may detect the connectivity options through wireless communications with one or more physical tags 117 that represent the connectivity options. By way of example, the UE 101 may detect an RF memory tag and/or a MMID tag where the UE 101 is equipped with various near field communication options and/or other connectivity devices. Upon one or more sensors, for example, and/or one or more applications 111 associated with the UE 101 detecting one or more physical tags representing one or more connectivity options, the information from the sensors and/or the applications may be sent to the connectivity manager 113 and/or the connectivity platform 103 so that the information may be incorporated into the user interface of the UE 101 along with the other symbols representing virtual tags corresponding with the other connectivity options. In one embodiment, the UE 101 may include more than one subscriber identity module (SIM). Information may be presented at the user interface based on connectivity options associated with either one or both of the SIMs. Thus, the symbols presented within the user interface may correspond to one or more virtual tags associated with the connectivity options and one or more physical tags associated with one or more connectivity options. Information regarding the physical tags may also be contained within information from one or more services 109 and/or content providers 115 so that the symbols representing the one or more physical tags may be represented at the user interface without having to physically scan or interface with the physical tags at the UE 101.

Where the connectivity options are associated with physical tags, the symbols associated with the physical tags may be dragged over the one or more activation areas of the user interface and/or the one or more tags representing one or more applications 111 active at the UE 101. By dragging the symbols to the activation areas and/or icons associated with the applications, the users of the UE 101 may interact with the physical tags to, for example, update information associated with the physical tags.

By way of example, a user is able to see and manipulate the content associated with a physical RF memory tag (e.g., an NFC tag, 8 GHz RF memory tag, 60 GHz MMID, etc.) through the user interface of the UE 101. If the physical tag is associated with, for example, a building (e.g., located on a building), the physical tag can provide information regarding the building to users viewing the information though their UE 101 as they are in the environment of the building. The information may be presented according to different levels established based on, for example, different levels of security, different levels of social network distances, etc. In one embodiment, users must receive invitations based on, for example, metadata, social network relations, etc. to enable the users to view the information regarding the tags. The invitations may be verified in the validation process of the users attempting to access the physical tags.

In one embodiment, the connectivity platform 103 allows for the creation of one or more digital suitcases that may collect and transform digital objects. The connectivity platform 103 may detect unused, passive objects from active used ones (or user selected digital objects that are mostly used, or the connectivity platform 103 selects the digital objects on behalf of the user based on user activities). The content can then be shared with, for example, another activation area of a user interface (e.g., a launch pad) or another UE 101b running a mixed-reality representation of an environment. By way of example, user A packs all needed digital objects (with computation and connectivity) to a portable digital suitcase and brings this suitcase into close proximity with another device to form a superset or common subset launch pad with another mixed-reality representation at the other device. With the connectivity superset, the connectivity platform 103 may enable bigger mixed-reality systems to be integrated or work in concatenated mode. Thus, the connectivity may form a virtual private network from one mixed-reality system to another mixed-reality system. With the connectivity subset, the connectivity platform 103 may enable limited (restricted) mixed-reality systems that are applicable within limited capability devices.

Based on the above, the connectivity platform 103 supports bringing a passive digital object from a suitcase to an activation area of a user interface (e.g., a launch pad) to activate the digital object. The digital object may then be dragged between two activation areas of two or more connected and mixed-reality systems. Physical tags 117 may also act as wireless access of the activation areas (e.g., launch pads) such that the activation areas can also be wirelessly connected to the mixed-reality system or integrated to the mixed-reality system.

In one embodiment, the connectivity platform 103 supports creating special areas within the user interface associated with the mixed-reality representation of the environment. The special areas may be considered personal pockets or a personal characteristic parts of the launch pad that are dedicated within the mixed-reality representation. The personal pockets may allow that user to set privacy and/or other needed restrictions of content, credentials or configurations, time of life, memory access restrictions, authorization to the user personal parts, etc. to the information that is within the personal pockets.

The connectivity platform 103 also provides assisted connectivity routing guidance. The guidance may provide directions associated with connectivity required computations, such as providing the user with instructions regarding how to position the UE 101 based on, for example, where the connectivity settings have the best match. By way of example, the mixed-reality representations of the environment may include color codes at the edge of the representation indicating what direction to turn the UE 101 for better connectivity. In one embodiment, different connectivity selections may have different assistance schemes. For example, cognitive radio (CR) consists of mid-range connectivity, RF memory tag systems consist of short range connectivity. When zooming through the mixed-reality representations with the assisted connectivity guidance, the connectivity may be presented according to different color coding (e.g., vibrancy, luminance changes) that change the selected connectivity to worse/better. Further, based on, for example, higher zoom, medium range cognitive radio connectivity may becomes less important and short range RF memory tag connectivity may become more important. This importance change with zoom changes the results of assisted connectivity routing and the presented connectivity options.

By way of example, the UE 101, the connectivity platform 103, the services platform 107, the content providers 115, the physical tags 117 and the connection points 119 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

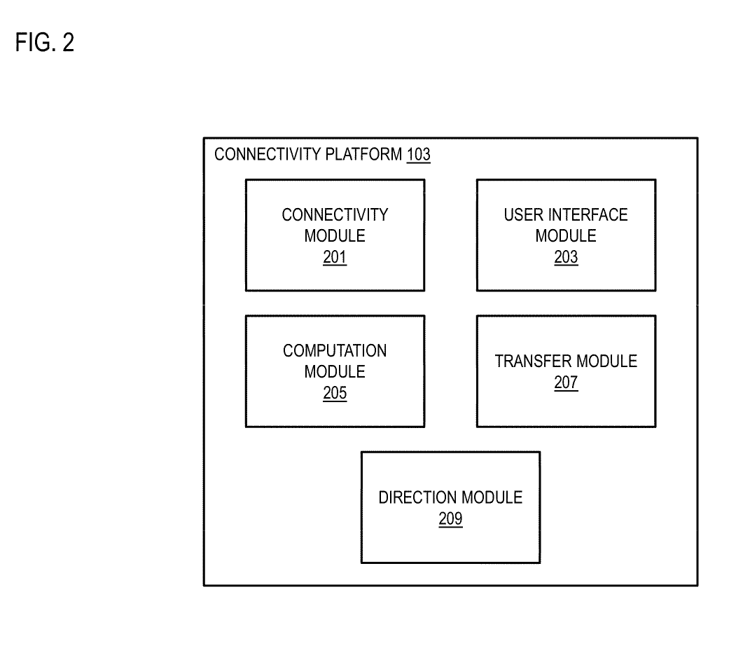

FIG. 2 is a diagram of the components of a connectivity platform 103, according to one embodiment. By way of example, the connectivity platform 103 includes one or more components for providing connectivity assistance and the seamless interaction with information sources through a mixed-reality environment. It is contemplated that the functions of these components may be combined in one or more components or performed by other components of equivalent functionality. By way of example, all of the functions of these components may be embodied in one or more services 109 and/or in the connectivity manager 113 associated with the UE 101. In this embodiment, the connectivity platform 103 includes a connectivity module 201, a user interface module 203, a computation module 205, a transfer module 207 and a direction module 209.

The connectivity module 201 may determine the connectivity options associated with an environment associated with a device, such as a UE 101. The connectivity module 201 may determine the connectivity options by interfacing with one or more of the services 109 and/or the content providers 115. The connectivity module 201 may also determine the one or more connectivity options based on information gathered from the UE 101, such as from the UE 101 scanning and/or interfacing with one or more connection points 119 and/or physical tags 117 within an environment. Thus, the connectivity module 201 determines the information associated with the connectivity options, which may include one or more connection points 119 (e.g., routers, base stations, cellular towers, etc.) and physical tags 117 (e.g., RF memory tag, MMID tag, etc.). The connectivity module 201 further determines the origin locations associated with the connectivity options. The origin location information may be included with the information from the one or more services 109 and/or the one or more content providers 115. The origin location information may also be gathered based on context information from the UE 101 that interfaces with one or more connection points 119 and/or physical tags 117. By way of example, the location of the UE 101 may be determined based on, for example, one or more sensors (e.g., GPS) and may be correlated with the information regarding the connection points 119 and/or physical tags 117. Along with the presence of the connectivity options and the locations associated with the connectivity options, the connectivity module 201 may also determine the data and/or computational structures associated with the connectivity options for establishing a connection with the connectivity options.

The user interface module 203 interfaces with the UE 101 and/or the connectivity managers 113 associated with the UE 101 for presenting the user interfaces at the UE 101 associated with providing information regarding the connectivity options. The user interface module 203 presents the information to the UE 101 to render the mixed-reality representations of the environment, such as providing the symbol associated with the connectivity options, including the size, shape, color, etc. associated with the symbols. The user interface module 203 further presents information to the UE 101 regarding the alignment information associated with the symbols such that the symbols representing the connectivity options may be presented according to the original location of the connectivity options. The user interface module 203 further generates the connection guidance indicator that provides information regarding all of the connectivity options available in the surrounding environment, not just the ones that are visible through the mixed-reality representation of the environment. The user interface module 203 may also provide the information to presenting turn indicators that provide additional information regarding the best connectivity, such as ideal connectivity, poor connectivity, and no connectivity, based on, for example, the number of connectivity options and the number of connections associated with the connectivity options.

The computation module 205 interfaces with the connectivity module 201 to process the data and/or computational structures associated with connectivity options that a user selects based on one or more selections and/or activation of symbols at the user interface corresponding to the connectivity options. The computation module 205 determines the characteristics and/or functionality of the user's device and processes the data and/or computational structures associated with the connectivity options to decompose the data and/or computational structures into software components. The computation module 205 may then process the software components or transfer the software components to the devices such that the devices process the software components to configure the hardware components of the devices to connect with the connectivity options.

The transfer module 207 effectuates a transfer of information between devices based on the connectivity options. The transfer module 207 may effectuate a transfer of information between two devices in a direct and/or indirect manner. A direct manner may be where two or more devices connect directly to each other, such as when one of the devices creates a connectivity option (e.g., a physical tag and/or a connection point). An indirect manner may be where two or more devices connect indirectly to each other by all connecting to a device that creates a connectivity option (e.g., such as where two devices connect to a router and/or a cellular communications network). The transfer module 207 may further perform validation processing prior to establishing a connection between devices and connectivity options, or before allowing the transfer of information between devices and connectivity options and/or other devices.

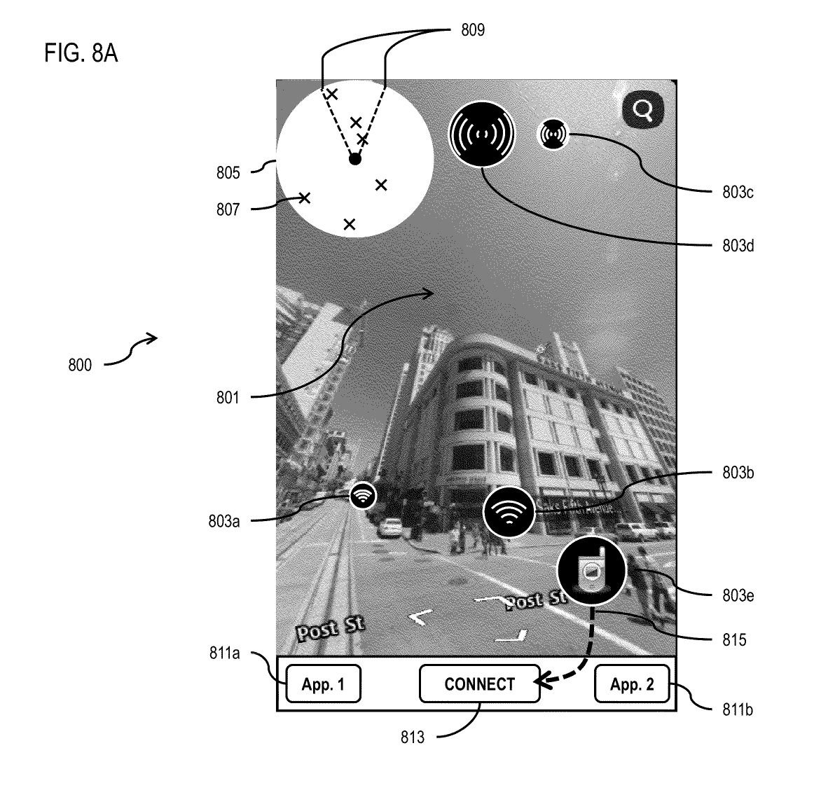

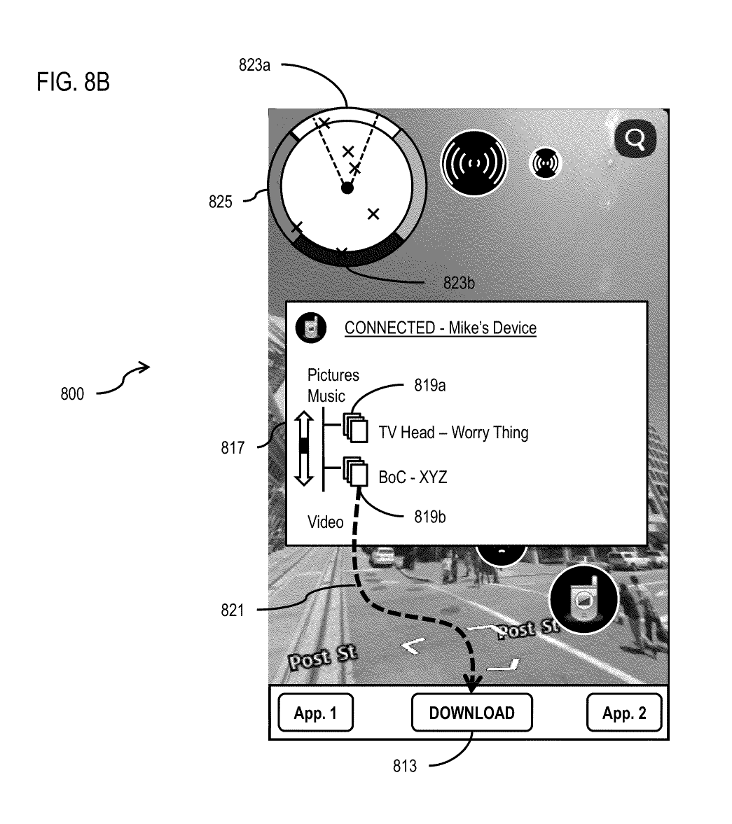

The direction module 209 provides additional directions to visualize the connectivity options. By way of example, the direction module 209 provides illustrative directions at the user interface regarding whether connectivity required computations are less or more complex associated with the connectivity options. Under this approach, the direction module is able to guide a user to turn the device to the right or another direction to obtain a position where the connectivity settings associated with the connectivity options have the best match for the particular user's device. The direction module 209 may provide guidance in the form of, for example, color-coded spheres (vibrancy changes, luminance change. etc.) or different edges of the user interface. The direction module 209 may provide visualizations and/or incentives for directing users such that a point-to-point connection can be made for distribution/synchronization of mixed-reality data, as illustrated and discussed below with respect to FIG. 8B.

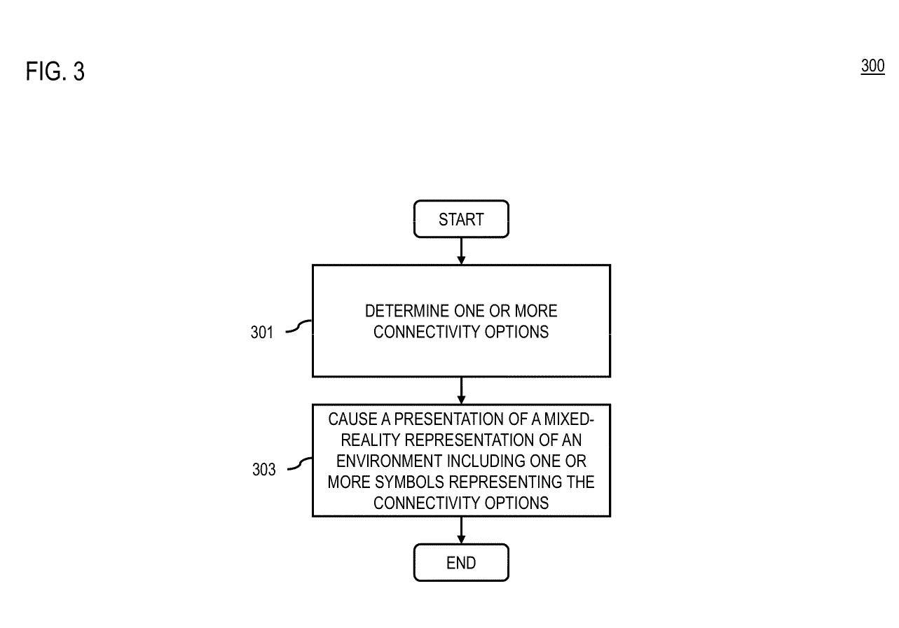

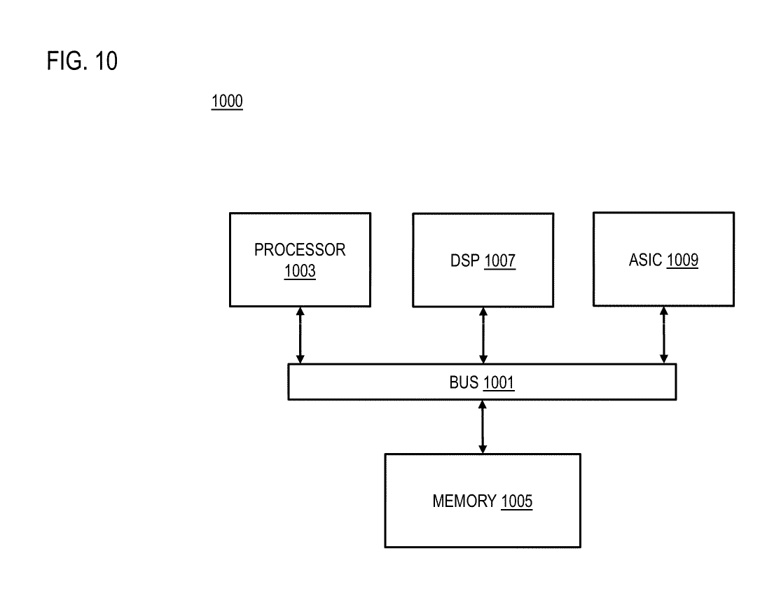

FIG. 3 is a flowchart of a process for presenting one or more connectivity options within a mixed-reality representation, according to one embodiment. In one embodiment, the connectivity platform 103 performs the process 300 and is implemented in, for instance, a chip set including a processor and a memory as shown in FIG. 10. In step 301, the connectivity platform 103 determines one or more connectivity options within an environment of at least one device. The connectivity platform 103 may determine the connectivity options by, for example, receiving information regarding the connectivity options from one or more information sources based on the location of the device. The information sources may be, for example, one or more services 109, one or more content providers 115, or a combination thereof. In one embodiment, the connectivity platform 103 may be associated with one or more databases that are independent from the services 109 and/or the content providers 115 that may store information regarding the connectivity options. The information stored at the databases may be initially determined based on information from the services 109 and/or content providers 115 and may be further updated based on information received from, for example, one or more devices connecting to the connectivity options over time.

The connectivity options may also be determined based on, for example, information detected by one or more UE 101 within the environment. For example, the UE 101 may detect physical tags that correspond with or represent connectivity options. The UE 101 may detect the connectivity options according to any wired or wireless method, such as cognitive radio, Bluetooth®, WiFi, cellular, etc. By way of example, when the UE 101 are equipped with multiple SIM cards, one SIM card may detect the presence of one type of cellular connectivity while the other SIM card can detect another type of cellular connectivity. When the UE 101 detect information regarding one or more connectivity options, the UE 101 may transmit the information to the connectivity platform 103 through, for example, the connectivity managers 113 located at the UE 101. Thus, the connectivity platform 103 may determine one or more connectivity options through the UE 101 rather than, or in combination with, one or more information sources, such as one or more services 109 and/or one or more content providers 115.

In step 303, the connectivity platform 103 causes, at least in part, a presentation of a mixed-reality representation of the environment of the device including one or more symbols representing the one or more connectivity options. The presentation is within a user interface of the device. The user is provided with a mixed-reality presentation that illustrates the connectivity options within the environment of the user. With this information, that user can connect to a wide range of connectivity options without having to know of the connectivity options based on the presence of the symbols representing the connectivity options. Further, the symbols can correlate to different information associated with the connectivity options. The symbols may vary based on, for example, their size, shape, color, or a combination thereof. Any one of these differences between the symbols may represent differences between the connectivity options in type, capacity, quality, price, and the like. The type may be based on general differences, such as short-range connectivity options, medium-range connectivity options, and long-range connectivity options. Additionally, the types may be based on specific differences, such as NFC, cognitive radio, WiFi, cellular, Bluetooth®, and the like. The other properties may similarly be based on general differences or on specific differences. Based on the foregoing, a user can quickly and easily see the various connectivity options that are available.

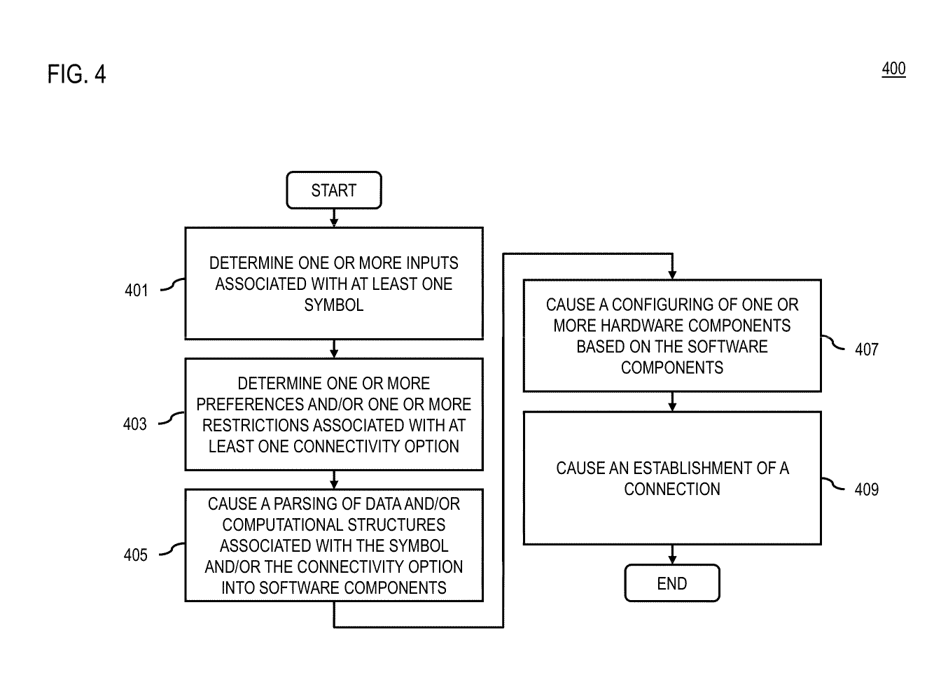

FIG. 4 is a flowchart of a process for establishing a connection between devices based on a mixed-reality representation of the connection option, according to one embodiment. In one embodiment, the connectivity platform 103 performs the process 400 and is implemented in, for instance, a chip set including a processor and a memory as shown in FIG. 10. In step 401, the connectivity platform 103 determines one or more inputs associated with at least one symbol of the one or more symbols presented at the user interface of the device. The one or more inputs may be any type of input, such as a tactile input (e.g., touch on a touch screen), an audio input, and/or or a visual input (e.g., eye detection). The input may select a symbol and associate the symbol with some form of activation. In one embodiment, the activation may be associated with dragging a symbol to an activation area on the user interface, such as a launch pad illustrated within the user interface. However, the input may be associated with any type of selection or activation associated with a symbol.

In one embodiment, at step 403, the connectivity platform 103 may determine one or more preferences, one or more restrictions, or a combination thereof associated with at least one connectivity option of the one or more connectivity options associated with the illustrated symbols. The one or more preferences may be associated with, for example, an automatic selection or activation of one or more symbols without requiring the inputs associated with step 301 above. By way of example, one preference associated with a connectivity option may be an automatic selection and activation of a symbol corresponding to a connectivity option when the symbol appears within the user interface of the device. For example, the connectivity option may be a trusted connectivity option or a favorite connectivity option. The one or more restrictions may be associated with restrictions regarding not presenting one or more symbols associated with the connectivity options within the user interface. For example, even if a UE 101a is compatible with a connectivity option, the user may have established a restriction associated with the connectivity option. Accordingly, the symbol is not presented within the user interface despite the connectivity option being within the environment associated with the UE 101a. Additionally although illustrated as subsequent to step 401, steps 401 and 403 in the process 400 may both occur or only one of the two may occur.

Based on either step 401 or step 403, or both, a symbol and/or connectivity option may be selected that a user would like to connect to with their UE 101a. Thus, at step 405, the connectivity platform 103 causes, at least in part, a parsing of data, one or more computational structures, or a combination thereof associated with the selected symbol into one or more software components. The connectivity platform 103 may determine the data and/or computational structures that are associated with the selected connectivity option and process these elements to determine the software components associated with establishing a connection between the UE 101a of the user and the connectivity option. The connectivity platform 103 may include the data and/or computational structures within one or more databases associated with the connectivity platform 103, or may receive the information initially when having received information regarding the connectivity option itself. By way of example, where the selected connectivity option is a WiFi connection, the connectivity platform 103 may determine the security settings associated with the WiFi connection and any other information associated with establishing a connection with the connectivity option.

In step 407, the connectivity platform 103 causes, at least in part, a configuring or one or more hardware components associated with the device (UE 101a) based, at least in part, on the software components. Depending on the type of connection selected, the connectivity platform 103 will cause a configuring of the associated hardware component of the UE 101a. Where, for example, the symbol selected is associated with a connectivity option based on Bluetooth®, the connectivity platform 103 will cause a configuring of the Bluetooth® modem associated with the device. After configuring the hardware associated with the UE 101a, in step 409, the connectivity platform 103 causes, at least in part, an establishment of at least one connection of the at least one device to the at least one connectivity option associated with a symbol presented at the user interface based, at least in part, on one or more inputs, on the one or more preferences, the one or more restrictions, or a combination thereof.

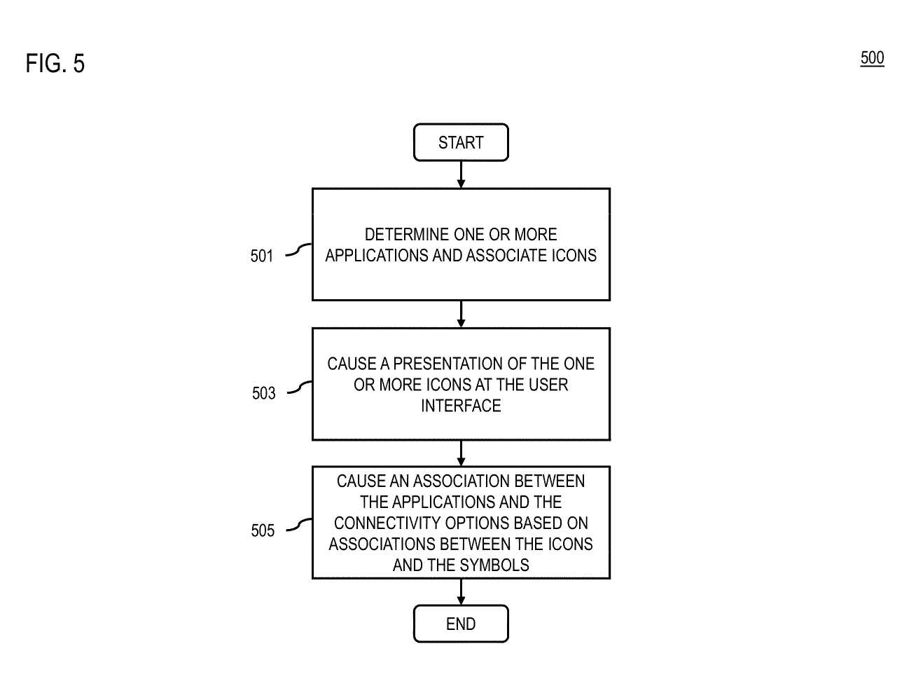

FIG. 5 is a flowchart of a process for associating an application at a mobile device with a connectivity option, according to one embodiment. In one embodiment, the connectivity platform 103 performs the process 500 and is implemented in, for instance, a chip set including a processor and a memory as shown in FIG. 10. In step 501, the connectivity platform 103 determines one or more applications associated with the at least one device and one or more icons associated with the one or more applications. The connectivity platform 103 may scan the UE 101 to determine the various applications 111 that are associated with the UE 101. The connectivity platform 103 may also determine one or more active applications 111 at the UE 101. In one embodiment, the connectivity platform 103 interfaces with the connectivity managers 113 at the UE 101 for determining the applications 111 and/or the active applications 111 at the UE 101. In one embodiment, an application 111a may be active if the application 111a is currently running and/or in active memory at the UE 101a. In one embodiment, the user of the UE 101a may select one or more of the applications 111 associated with the connectivity platform 103 determining the applications. In one embodiment, the user may activate one or more applications 111 associated with the connectivity platform 103 determining the one or more applications 111.

Upon determining the one or more applications 111, the connectivity platform 103 further determines one or more icons associated with the applications 111. The icons may be generated icons associated with the name of the applications 111 and/or one or more graphics related to the applications 111 (such as one or more graphic icons created by the creator of the applications 111). The icons may be unique to the particular application 111a that the icon represents such that the user can distinguish that the icon pertains to the particular application 111a.

In step 503, the connectivity platform 103 causes, at least in part, a presentation of the one or more icons at the user interface. In one embodiment, the icons associated with the applications 111 may be presented around the edge of the user interface such that they surround the mixed-reality presentation of the environment. In one embodiment, the icons may be grouped according to the type of application each icons represents and be presented within folders in the user interface. The icons within the folders may be accessed by the user of the device accessing each individual folder.

In step 505, the connectivity platform 103 causes, at least in part, an association between the one or more applications and the one or more connectivity options presented at the user interface based, at least in part, on one or more associations of the one or more icons and the one or more symbols representing the connectivity options within the user interface. The association may establish a connection between an application and a connectivity option such that, for example, communications from the UE 101a originating from the selected application use the selected connectivity option associated with the selected symbol. By way of example, a UE 101a may be running a navigational application 111b. The user of the UE 101a may associate the navigation application 111b with a WiFi connectivity option that is within the environment of the UE 101a. Further, the UE 101a may be running an e-mail application 111c, and the user may associate the e-mail application 111c with a cellular connectivity option within the environment of the UE 101a.

The user may effectuate the association by selecting an icon associated with an application and a symbol associated with a connectivity option. The selections may occur based on tactile selections at the user interface, audio selections, visual selections, or a combination thereof. By way of example, the user may select an icon associated with an application by touching the icon in a touch screen interface. The user may then drag the selected icon over a symbol representing a connectivity option and release their finger over the symbol; thus associating the application with the connectivity option. However, whether the user selects the application first or the connectivity option first is irrelevant. The above may be effectuated by the user first selecting the symbol representing the connectivity option and then selecting the icon representing the application by dragging the symbol over the icon and releasing the icon.

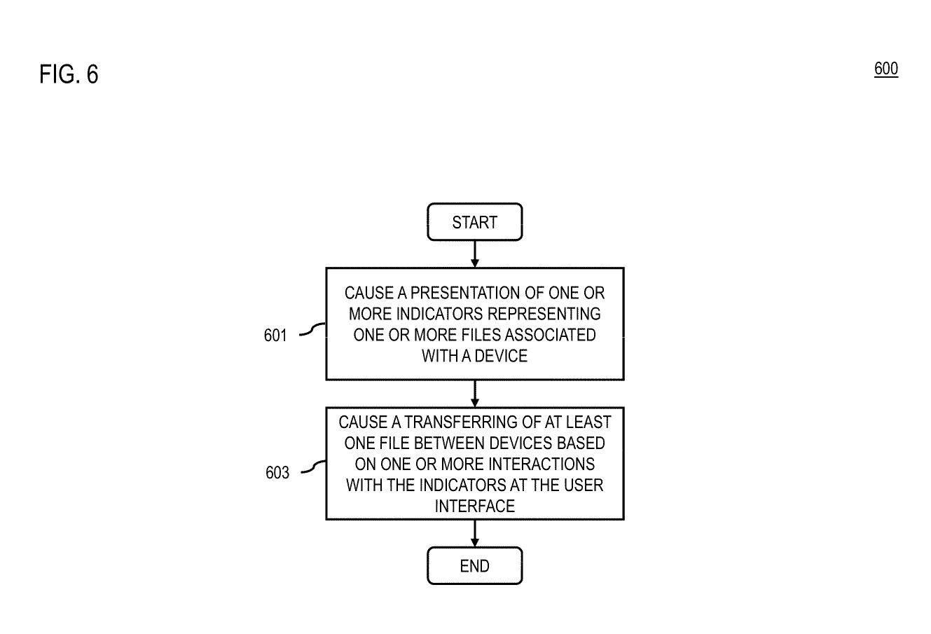

FIG. 6 is a flowchart of a process for transferring information between sources through a mixed-reality representation, according to one embodiment. In one embodiment, the connectivity platform 103 performs the process 600 and is implemented in, for instance, a chip set including a processor and a memory as shown in FIG. 10. One of the connectivity options may be associated with another device that includes the capacity to store one or more digital objects, such as one or more files. By way of example, a connectivity option may be associated with a mobile device, such as a UE 101, or other computing device that is able to establish a direct-to-direct connection with another device. Further, a connectivity option may allow a connection between two devices, such as a wireless router providing a connection between two devices. Further, the other devices may be a physical tag 117 that has the capability to store information.

In step 601, at least two devices form a connection using at least one connectivity option. Subsequently, the connectivity platform 103 causes, at least in part, a presentation within the user interface of one or more indicators representing one or more digital objects (e.g., files) associated with at least one of the devices that are connected by way of the connectivity point. For example, a user may connect to another device by dragging a symbol representing the other device, which also represents a connectivity option, to a launch pad. An area of the user interface may then display files associated with the user's device or with the device the user just connected to, or both. By way of example, the user interface may display a digital suitcase containing digital objects, such as one or more files, that the user may then select within the user face according to any type of selection (such as touching associated with a user interface). Additionally, or in the alternative, the user interface may display one or more indicators associated with digital objects (such as one or more files) that are located on the device the user connected to and may allow the user to select one of the digital objects according to any type of selection.

In step 603, the connectivity platform 103 causes, at least in part, a transferring of at least one file of the one or more files between the two or more devices that are connected based on the connectivity option based, at least in part, on one or more interactions with the one or more indicators at the user interface. The interactions may include, for example, a user dragging an indicator of a digital object within the user interface of one device to a representation of the other device within the user interface and releasing the digital object. Based on this action, the connectivity platform 103 will transfer the digital object represented by the indicator from the one device to the other device. However, the selection of the file represented by the indicator may be effectuated according to any type of selection, such as a visual selection or an audio selection. Further, in one embodiment, the transfer of the file between the two or more devices may be automatic based on one or more set preferences; for example, upon two or more devices connecting that are associated with a list of devices. According to the above process 600, a user may approach a physical tag (e.g., an RF memory tag) that is represented by a symbol within a mixed-reality representation. The user may connect to the physical tag by selecting the symbol representing the physical tag or by physical interacting with the tag, such through NFC communications. The user may then select one or more digital objects on the user's device to transfer to the physical tag by dragging one or more of the digital objects over the symbol representing the physical tag.

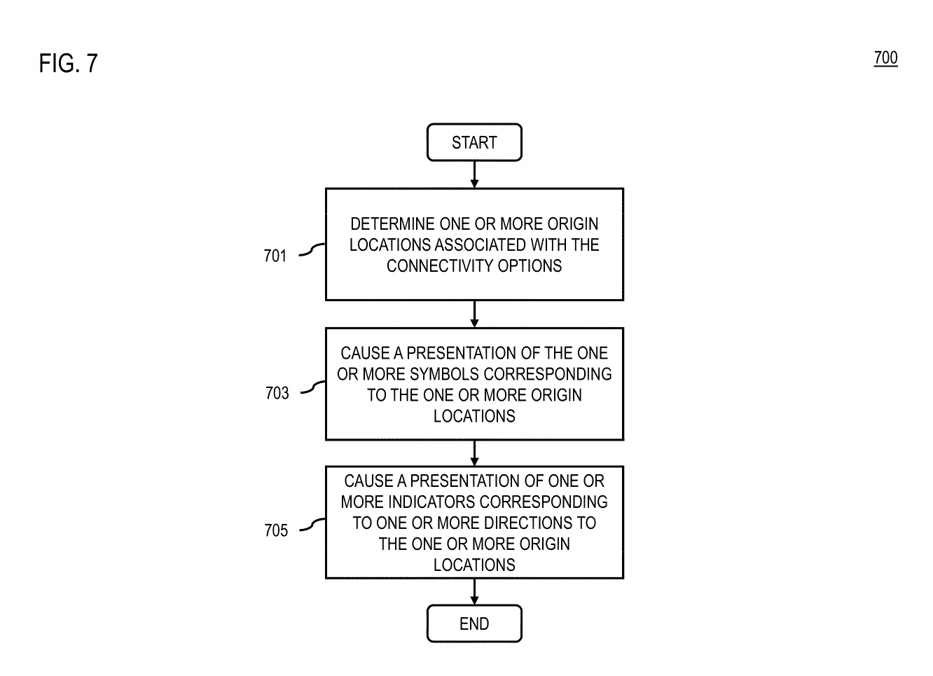

FIG. 7 is a flowchart of a process for providing direction assistance associated with connectivity options through a mixed-reality representation, according to one embodiment. In one embodiment, the connectivity platform 103 performs the process 700 and is implemented in, for instance, a chip set including a processor and a memory as shown in FIG. 10. In step 701, the connectivity platform 103 determines one or more origin locations associated with the one or more connectivity options. The connectivity platform 103 may determine the one or more origin locations associated with the connectivity options based, at least in part, on one or more services 109 and/or one or more content providers 115 that provide the information regarding the connectivity options. For instance, along with the existence information, data and computational structures for the connectivity options, the services 109 and/or content providers 115 may provide location coordinates associated with the origin locations of the connectivity options. For example, where the connectivity option is associated with WiFi, the connectivity platform 103 may be provided with the origin location of the base station that is broadcasting the WiFi signal. Where the connectivity option is associated with a cellular signal, the origin location may correspond with the area of coverage of the cellular signal.

In step 703, the connectivity platform 103 causes, at least in part, a presentation of the one or more symbols within the mixed-reality representation corresponding to the one or more origin locations. Accordingly, when the user views the mixed-reality representation of the surrounding environment, the location of the symbol within the representation corresponds with the origin location of the connectivity. By way of example, where a building is offering free WiFi, a symbol associated with the connectivity option of the free WiFi is presented over the building within the mixed-reality representation. Further, where another device, such as a UE 101b, is compatible with Bluetooth® connectivity, a symbol associated with the device representing the connectivity option associated with the device may appear over the device in the mixed-reality representation. For long-range connectivity options that may not have one or a few number of origin locations, such as cellular connectivity options, the symbol representing these connectivity options may be presented generally within the mixed-reality representation, such as at the top of the mixed-reality representation. However, where, for example, a cell tower associated with the cellular coverage is within view of the mixed-reality representation, the connectivity platform 103 may cause a symbol representing the connectivity option of the cellular coverage to be presented over the cell tower.

In step 705, the connectivity platform 103 may further cause, at least in part, a presentation of one or more indicators associated with the one or more origin locations corresponding to one or more directions to the one or more origin locations within the user interface relative to a location of the at least one device. The presentation of the one or more indicators may correspond with a radar view illustrating the position of the connectivity options surrounding the user such that a 360 degree view of the connectivity options is presented. The view may distinguish the connectivity options that are currently in view within the mixed-reality representation and the connectivity options that are currently out of view. Thus, although one or more connectivity options are not within view in the mixed-reality representation such that the symbols are presented over the origin locations, the user may still understand which way to turn the device such that the origin locations are in view.

Further, in one embodiment, the presentation of the one or more indicators may display information regarding which of the connectivity options is associated with more or less computations associated with the connectivity routing. Thus, the one or more indicators may guide the user to turn the device to the right/left/or some other direction to where the connectivity settings associated with the connectivity options have the best match corresponding to, for example, the device associated with the user. This information may also be presented in the form of indicators at the edge of the mixed-reality representation of the environment. Accordingly, the user is presented with a quick an easy presentation of indicators that allow for the user to connect to one or more connectivity options that are available within an environment surrounding the user.

FIGS. 8A and 8B are diagrams of user interfaces utilized in the processes of FIGS. 3-5, according to various embodiments. FIG. 8A illustrates the user interface 800, which may be the user interface of a UE 101a. The user interface 800 presents a mixed-reality representation 801 of the environment surrounding the UE 101a. As illustrated, the mixed-reality representation 801 provides one or more live images and/or video of the environment (e.g., the street corner) with overlaid information. The overlaid information may include symbols 803a-803e that represent connectivity options that are within the environment of the UE 101a. The symbols 803a-803e may vary according to, for example, size and shape. For example, symbols 803a and 803b may represent WiFi connectivity options based on the particular shape of the symbol. Symbols 803c and 803d may represent cellular connectivity options. Symbol 803e may represent a Bluetooth® connectivity option (e.g., a device-to-device connectivity option). Further, in one embodiment, the size of the symbols 803a-803e may represent the strength of the signals associated with the connectivity options. Because the size of the symbol 803a is smaller than the size of the symbol 803b, for the same type of symbol (e.g., WiFi), the signal associated with the connectivity option represented by symbol 803b may be stronger than the signal associated with the connectivity option represented by symbol 803a. The same may be true for symbols 803c and 803d.

In an alternative embodiment, the size of the symbol may represent a distance the origin location of the represented connectivity option is from the UE 101a. For example, since the symbol 803a is smaller than the symbol 803b, the origin location associated with the connectivity option represented by symbol 803a may be farther away than the origin location associated with the connectivity option represented by symbol 803b. In such an embodiment, the symbols 803a-803e may be positioned within the mixed-reality representation 801 of the environment such that the symbols 803a-803e correspond with the origin locations of the connectivity options.

The user interface 800 may also include a connection guidance indicator 805. The connection guidance indicator 805 may illustrate within the user interface 800 a 360 degree view of the available connectivity options within the surrounding environment. Each one of the indicators 807 may represent a connectivity option. In one embodiment, each one of the indicators 807 may represent a connectivity option that corresponds to a discrete origin location, such that, for example, cellular connectivity options that may have multiple origin locations (e.g., cell towers) are not represented within the connection guidance indicator. Thus, only symbols 803a, 803b and 803e are represented by indicators 807 within connection guidance indicator 805. The remaining indicators 807 within the connection guidance indicator 805 may be out of the field of view of the mixed-reality representation, which is illustrated by lines 809.

The user interface 800 may also include icons 811a and 811b corresponding to one or more applications 111 associated with the UE 101. By way of example, the icons 811a and 811b may be associated with one or more Internet browsing applications, one or more email applications, and the like. The user interface 800 also includes an activation area 813 (e.g., a launch pad). The activation area 813 may allow a user to activate one or more connectivity options associated with the illustrated symbols 803a-803e and/or one or more of the icons 811a and 811b associated with the applications 111. By way of example, a user may select the symbol 803e and drag the symbol 803e to the activation area 813 to connect the UE 101a with the connectivity option associated with the symbol 803e, in this case another UE 101, as indicated by the dashed arrow 815. The user may alternatively drag the symbol 803e to the icon 811a to associate the application corresponding to the icon 811a with the connectivity option 803e. Thus, the user interface 800 provides a graphical way for users to see the connectivity options that are available within the users' environments and easily connect to the connectivity options based, for example, on interactions with the corresponding symbols.

In one embodiment, the user interface 800 may allow a zooming function associated with the mixed-reality representation of the environment. Under such a scenario, different connectivity options may have different presence schemes within the mixed-reality representation. For example, long-range connectivity options may be illustrated when the mixed-reality representation is zoomed out showing a wide angel view of the environment. Medium-range and short-range connectivity options may also be included in such a representation. Upon zooming in to the mixed-reality representation, the long-range connectivity options may be excluded and only the medium-range to short-range connectivity options may be illustrated. Further, upon zooming in to the mixed-reality representation even more, the medium-range connectivity options may be excluded such that only the short-range connectivity options are illustrated. This dominance change associated with the zoom results in further assistance in providing connectivity options.

FIG. 8B illustrates the user interface 800 when a connection is established between the UE 101a associated with the user interface 800 and a connectivity option, which in this case is another UE 101b. However, the UE 101a may connect to any other type of connectivity option, such as a physical tag 117, a wired and/or wireless router, cognitive radio, cellular signal, etc. and may also interact with other devices connected to the same connectivity options. The user interface 800 may include a menu 817 that provides information regarding digital objects on the UE 101b that the user of the UE 101a connected to. In one embodiment, the menu 817 may correspond with a digital suitcase that includes digital objects that the user of the UE 101b selected and placed in the digital suitcase. The user of the UE 101a may transfer some of the digital objects to the UE 101a based on one or more interactions associated with the indicators 819 (819a and 819b) corresponding to the digital objects within the menu 817. By way of example, a user may select the indicator 819b based on touching the indicator using a touch screen interface and dragging the indicator 819b over the activation area 813 to activate a transfer of the digital object on the UE 101b to the UE 101a, as indicated by the dashed arrow 821.

FIG. 8B also illustrates a different version of the connection guidance indicator 805 illustrated in FIG. 8A. The connection guidance indicator 825 may provide assistance with respect to how turning the device will change the connectivity options. The connection guidance indicator 825 may include turn indicators 823 (such as turn indicators 823a and 823b) that illustrate, for example, a dense connectivity area where a large number of connections are already in use associated with the connectivity options, a no connectivity where there are no connectivity options, an ideal connectivity area where there are a large number of connectivity options that include few established connections, and so forth. By way of example, in the current connection guidance indicator 825 of FIG. 8B, turn indicator 823a being white may represent an area of ideal connectivity where there are a large number of connectivity options and each connectivity option has few connection established. However, the turn indicator 823b may indicate that if the UE 101a moves backwards, the UE 101a will enter into a no connectivity area where there are no connectivity options. The two turn indicators on either side may illustrate some degree of connectivity between ideal and no connections, as represented by the shades of gray. Although the turn indicators 823 are illustrated within the connection guidance indicator 825, the turn indicators 823 may instead be located on the sides of the mixed-reality representation of the environment.

The processes described herein for providing connectivity assistance and the seamless interaction with information sources through a mixed-reality environment may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

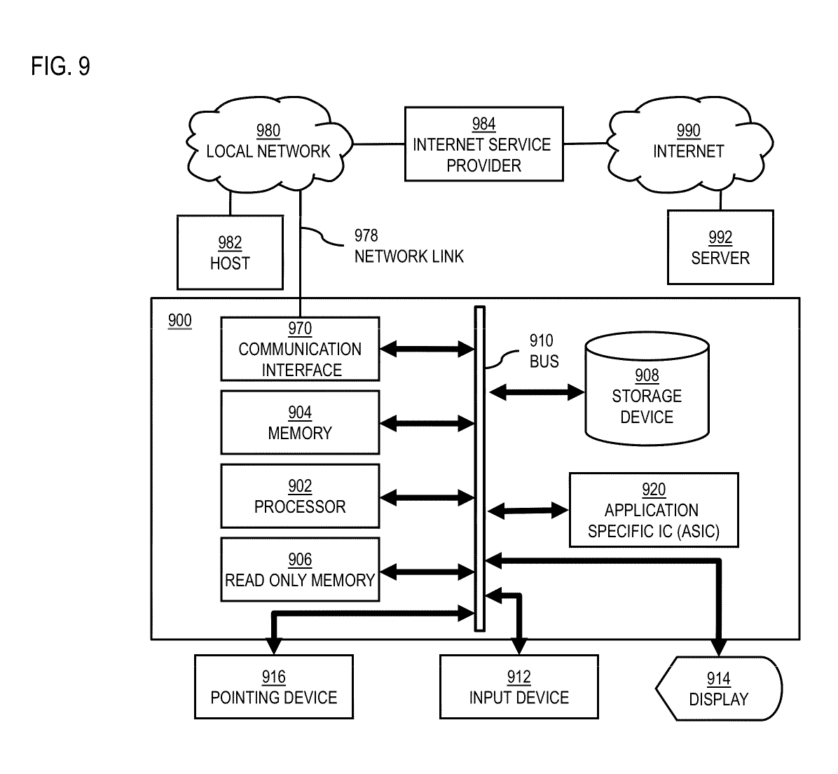

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide connectivity assistance and the seamless interaction with information sources through a mixed-reality environment as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of providing connectivity assistance and the seamless interaction with information sources through a mixed-reality environment.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to providing connectivity assistance and the seamless interaction with information sources through a mixed-reality environment. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for providing connectivity assistance and the seamless interaction with information sources through a mixed-reality environment. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing connectivity assistance and the seamless interaction with information sources through a mixed-reality environment, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for providing connectivity assistance and the seamless interaction with information sources through a mixed-reality environment to the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to provide connectivity assistance and the seamless interaction with information sources through a mixed-reality environment as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of providing connectivity assistance and the seamless interaction with information sources through a mixed-reality environment.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide connectivity assistance and the seamless interaction with information sources through a mixed-reality environment. The memory 1005 also stores the data associated with or generated by the execution of the inventive steps.

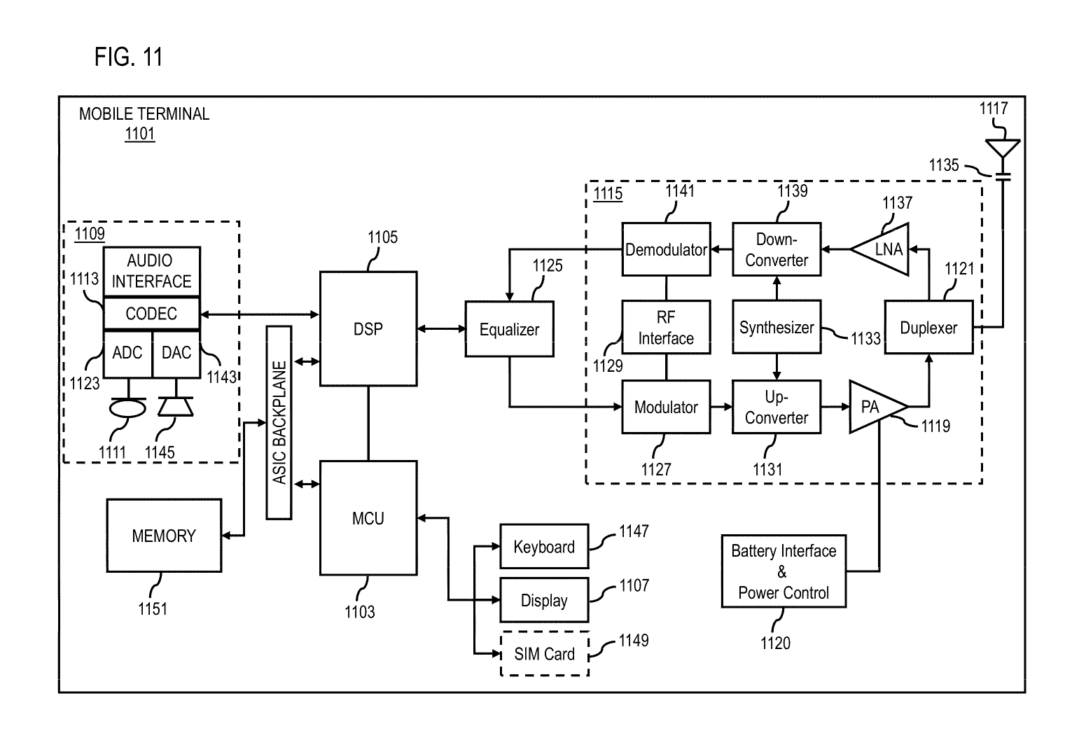

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of providing connectivity assistance and the seamless interaction with information sources through a mixed-reality environment. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing connectivity assistance and the seamless interaction with information sources through a mixed-reality environment. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide connectivity assistance and the seamless interaction with information sources through a mixed-reality environment. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
one or more connectivity options within an environment of at least one device; and
a presentation, within a user interface of the at least one device, of a mixed-reality representation of the environment including one or more symbols representing the one or more connectivity options.

2. A method of claim 1, wherein the (1) data and/or (2) information and/or (3) at least one signal are further based, at least in part, on the following:
one or more inputs associated with at least one symbol of the one or more symbols at the at least one device; and
an establishment of at least one connection of the at least one device to at least one connectivity option associated with the at least one symbol based, at least in part, on the one or more inputs.

3. A method of claim 2, wherein the (1) data and/or (2) information and/or (3) at least one signal associated with the establishment of the at least one connection are further based, at least in part, on the following:
a parsing of data, one or more computational structures, or a combination thereof associated with the at least one symbol into one or more software components; and
a configuring of one or more hardware components associated with the at least one device based, at least in part, on the software components.

4. A method of claim 1, wherein the (1) data and/or (2) information and/or (3) at least one signal are further based, at least in part, on the following:
one or more preferences, one or more restrictions, or a combination thereof associated with at least one connectivity option of the one or more connectivity options; and
an establishment of at least one connection of the at least one device to the at least one connectivity option based, at least in part, on the one or more preferences, the one or more restrictions, or a combination thereof.

5. A method of claim 1, wherein the (1) data and/or (2) information and/or (3) at least one signal are further based, at least in part, on the following:
one or more applications associated with the at least one device and one or more icons associated with the one or more applications;
a presentation of the one or more icons at the user interface; and
an association between the one or more applications and the one or more connectivity options based, at least in part, on one or more associations of the one or more icons and the one or more symbols within the user interface.

6. A method of claim 1, wherein one or more connectivity options are respectively associated with one or more other devices, and wherein the (1) data and/or (2) information and/or (3) at least one signal are further based, at least in part, on the following:
a presentation within the user interface of one or more indicators representing one or more files associated with at least one of the one or more other devices; and
a transferring of at least one file of the one or more files between the at least one of the one or more other devices and the at least one device, at least another of the one or more other devices, or a combination thereof based, at least in part, on one or more interactions with the one or more indicators at the user interface.

7. A method of claim 6, wherein the user interface includes at least one activation area, and the one or more interactions comprise dragging at least one indicator representing the at least one file to the at least one activation area.

8. A method of claim 1, wherein the (1) data and/or (2) information and/or (3) at least one signal are further based, at least in part, on the following:
one or more origin locations associated with the one or more connectivity options; and
a presentation of the one or more symbols within the mixed-reality representation corresponding to the one or more origin locations.

9. A method of claim 8, wherein the (1) data and/or (2) information and/or (3) at least one signal are further based, at least in part, on the following:
a presentation of one or more indicators associated with the one or more origin locations corresponding to one or more directions to the one or more origin locations within the user interface relative to a location of the at least one device.

10. A method of claim 1, wherein a size, a shape, a color, or a combination thereof of the one or more symbols visually indicate a type, a capacity, a quality, a price, or a combination thereof of the one or more connectivity options.

11. An apparatus comprising:
at least one processor; and
at least one memory including computer program code for one or more programs,
the at least one memory and the computer program code configured to, with the at least one processor, cause the apparatus to perform at least the following,
determine one or more connectivity options within an environment of at least one device; and
cause, at least in part, a presentation, within a user interface of the at least one device, of a mixed-reality representation of the environment including one or more symbols representing the one or more connectivity options.

12. An apparatus of claim 11, wherein the apparatus is further caused to:
determine one or more inputs associated with at least one symbol of the one or more symbols at the at least one device; and
cause, at least in part, an establishment of at least one connection of the at least one device to at least one connectivity option associated with the at least one symbol based, at least in part, on the one or more inputs.

13. An apparatus of claim 12, with respect to the establishment of the at least one connection, the apparatus is further caused to:
cause, at least in part, a parsing of data, one or more computational structures, or a combination thereof associated with the at least one symbol into one or more software components; and
cause, at least in part, a configuring of one or more hardware components associated with the at least one device based, at least in part, on the software components.

14. An apparatus of claim 11, wherein the apparatus is further caused to:
determine one or more preferences, one or more restrictions, or a combination thereof associated with at least one connectivity option of the one or more connectivity options; and
cause, at least in part, an establishment of at least one connection of the at least one device to the at least one connectivity option based, at least in part, on the one or more preferences, the one or more restrictions, or a combination thereof.

15. An apparatus of claim 11, wherein the apparatus is further caused to:
determine one or more applications associated with the at least one device and one or more icons associated with the one or more applications;
cause, at least in part, a presentation of the one or more icons at the user interface; and
cause, at least in part, an association between the one or more applications and the one or more connectivity options based, at least in part, on one or more associations of the one or more icons and the one or more symbols within the user interface.

16. An apparatus of claim 11, wherein one or more connectivity options are respectively associated with one or more other devices, and wherein the apparatus is further caused to:
cause, at least in part, a presentation within the user interface of one or more indicators representing one or more files associated with at least one of the one or more other devices; and
cause, at least in part, a transferring of at least one file of the one or more files between the at least one of the one or more other devices and the at least one device, at least another of the one or more other devices, or a combination thereof based, at least in part, on one or more interactions with the one or more indicators at the user interface.

17. An apparatus of claim 16, wherein the user interface includes at least one activation area, and the one or more interactions comprise dragging at least one indicator representing the at least one file to the at least one activation area.

18. An apparatus of claim 11, wherein the apparatus is further caused to:
determine one or more origin locations associated with the one or more connectivity options; and
cause, at least in part, a presentation of the one or more symbols within the mixed-reality representation corresponding to the one or more origin locations.

19. An apparatus of claim 18, wherein the apparatus is further caused to:
cause, at least in part, a presentation of one or more indicators associated with the one or more origin locations corresponding to one or more directions to the one or more origin locations within the user interface relative to a location of the at least one device.

20. An apparatus of claim 11, wherein a size, a shape, a color, or a combination thereof of the one or more symbols visually indicate a type, a capacity, a quality, a price, or a combination thereof of the one or more connectivity options.

21-48. (canceled)
